(19) United States
(12) Patent Application Publication
(10) Pub. No.: US 2003/0048054 A1
(43) Pub. Date: Mar. 13, 2003

(54) Artificial solar wind generator

(75) Inventor: Kei-Ichi Hirano, Kuwana-gun (JP)

Correspondence Address: OLIFF & BERRIDGE, PLC, P.O. BOX 19928, ALEXANDRIA, VA, 22320, US

(73) Assignee: NATIONAL INSTITUTE FOR FUSION SCIENCE, Toki City (JP)

(21) Appl. No.: 10/123,232

(22) Filed: Apr. 17, 2002

(30) Foreign Application Priority Data
Sep. 11, 2001 (JP) 2001-274,871

(51) Int. Cl. H05H 3/00

(52) U.S. Cl. 313/231.41; 313/231.31

(57) ABSTRACT

A gas flow from a gas reservoir is accelerated up to supersonic velocity beyond the throat of a Laval nozzle. The accelerated supersonic gas flow is introduced into a plasma generating preaccelerating system, and thereby converted into the plasma flow of the velocity close to the thermal's. Then, the primary plasma flow is introduced into an arcjet discharger, to be accelerated to super thermal velocity by the viscosity force, similar to a sonic wind.

### BACKGROUND OF THE INVENTION

1. Field of the Invention

This invention contributes to the enhancement of the performance of an arcjet discharger, particularly relating to an artificial solar wind generator usable for a plasma source for electromagnetic accelerator, an electric ship propulsion rocket, a particle injector for plasma-confining apparatus.

2. Description of the related art

An arcjet discharger is a simple super high energy plasma beam generator, where two kinds of energy such as thermal energy from super high temperature plasma and translational kinetic energy from plasma beam can be provided. At present, the arcjet discharger is employed only as thermal energy source, almost not as translational kinetic energy source.

As the use of the arcjet discharger for translational kinetic energy source, a plasma jet type space propeller which is developed at NASA in USA can be exemplified. As of now, the specific impulse of the propeller is about 1000 seconds, which is almost twice as large as that of a chemical rocket engine. That specific impulse is only about one-two hundredth of the theoretical maximum value [k. Hirno, Phys Plasmas 8, 1743 (2001)], so can be improved remarkably.

Also, as the use of the arcjet discharger for translational kinetic energy source, a plasma beam source to be installed in an electromagnetic accelerator can be exemplified. In this case, however, a plasma flux having a velocity of more than the thermal velocity is required, so desired to be improved.

As of now, the arcjet discharger is being improved so that a plasma beam at lower velocity level than the thermal velocity is converted into a high energy plasma beam at higher velocity level than the thermal velocity. If improved, the arcjet discharger can be employed for a space electric propeller of higher specific impulse, a plasma source for electromagnetic accelerator and a particle injector for nuclear fusion apparatus, which require plasma beams of higher translational kinetic energy, and thus, expected for various field applications.

### SUMMARY OF THE INVENTION

It is an object of the present invention to provide an artificial solar wind generator usable for various fields, through the improvement and the development of an arcjet discharge.

For achieving the above object, this invention relates to an artificial solar wind generator including an arcjet discharger, whereby a primary plasma flow is injected into the arcjet discharger from the upstream end thereof along the arc discharging axis thereof, and is accelerated up to supersonic velocity, similar to a solar wind.

In a preferred embodiment of the present invention, a plasma generating preaccelerating system to generate the primary plasma flow is provided in runup to the arcjet discharger.

In another preferred embodiment of the present invention, a Laval nozzle or a gas supplying tube having a throat portion which is equivalent to the Laval nozzle is provided in the run-up to the plasma generating preaccelerating system. In this case, a given gas flow is supplied to the plasma generating preaccelerating system via the region of the Laval nozzle or the gas-supplying tube where the sectional area is set to minimum, to generate the gas flow up to supersonic velocity, in order to generate the primary plasma flow.

In still another embodiment of the present invention, a gas flow controlling apparatus to supply the gas flow to the minimum sectional area portion of the Laval nozzle or the gas supplying tube at sonic velocity is provided.

The plasma acceleration using the arcjet discharger is performed on the principle of accelerating a given gas flow by utilizing the thermal energy of the arc. In consideration of the artificial solar wind composed of a plasma flow of extreme higher translational kinetic energy being generated on the same principle, it is concluded that a high energy plasma beam can be generated by the arcjet discharger.

Until now, only a lower energy level plasma flow having a velocity of less than the thermal velocity can be generated by the arcjet discharger, and then, a higher energy level plasma as desired can not be generated. The reason is that the injecting velocity of gas flow into the discharger is lower than the critical velocity required. According to the present invention, the injecting velocity of gas flow can be enhanced and thus, the above problem can be solved. That is, according to the present invention, a high energy level plasma beam equivalent to an solar wind can be generated by only a simple arcjet discharger.

According to Parker's classic model that an solar wind is generated by the affection of a “gravitation nozzle” equivalent to a Laval nozzle which is generated by gravitation, there is a critical value for the supplying velocity of a plasma flow from the solar surface [E. N. Parker, in Interplanetary Dynamic Process (Interscience, New York, 1963). If the supplying velocity of the plasma flow is below the critical value. only the plasma of the “breeze Mod” appears. In this case, the plasma flow is accelerated once, and then, deaccelerated. Therefore, the plasma flow is not converted into as a solar wind, and the velocity of the plasma flow remains the low velocity less than the thermal velocity.

According to Parker' theory, an arcjet discharger available at present can be operated only at the “breeze mode”. Therefore, the present invention relates to the conversion to “solar wind mode” operation from the “breeze mode” operation. In an arcjet discharger, the extremely large difference in temperature between the gas inlet and the arc column plays an important role. A gas flow with the temperature difference is called as a “Rayleigh flow”, which has been utilized in various fields from a long time ago and can be considered precisely.

In a Rayleigh flow through a tube having a constant area cross-section, a given gas flow according to the Rayleigh flow is accelerated by the thermal difference if the velocity of the gas flow is subsonic velocity, and deaccelerated if the velocity of the gas flow is supersonic velocity. Also, that similar phenomenon occurs in a gas flow through a converging nozzle is well known. Therefore, when a given gas flux is flown to a main arc column of extremely high temperature from a run-up preheating and accelerating system, the gas flow is driven up by the temperature gradient along the flow. Therefore, the gas flow is flown as in the converging nozzle, and an “equivalent shrinkage tube” can be constructed by the run-up preheating and accelerating system. In this case, by controlling the injecting velocity of the gas flow into the equivalent converging tube, the gas flow is accelerated up to the thermal velocity at the exit of the equivalent converging tube in the sonic velocity condition, that is, the plasma condition.

The acceleration to the thermal velocity of the gas flow at the inlet of the main arc column can be done by controlling the throat portion of a Laval nozzle so that the gas flow injected is accelerated to sonic velocity. Practically, the acceleration can be realized by setting the pressure in the tube to be 0.52 times of the total pressure of the operation flux before discharge and igniting the main arc column.

In this case, the tube is composed of an enlarged nozzle and a converging nozzle. As the tube, a supersonic stationary wind tunnel well known can be exemplified, but quite different from the above-mentioned system in gas flow. In a normal supersonic wind cavity, for recovering the reservoir pressure, the minimum sectional area of the converging nozzle is not set smaller than the minimum sectional area of the enlarged nozzle. Since this invention is performed on the equivalent converging nozzle formed due to the increase of the temperature of the gas flow by heating, and the arc temperature is extremely larger than the temperature of the gas flux to be injected, the minimum sectional area of the equivalent converging nozzle is set extremely smaller than the minimum sectional area of the enlarged nozzle. In this case, the gas flow through the enlarged nozzle is extremely decelerated to subsonic velocity from supersonic velocity. That is, the supersonic gas flow is converted into a subsonic gas flow. Since the perturbation in the supersonic gas flow is not propagated toward the upstream, the deceleration to subsonic velocity from supersonic velocity is done by the shock wave.

The subsonic gas flow in the downstream from the shock wave surface is decelerated at the enlarged nozzle once, and then, accelerated at the equivalent converging nozzle again due to the temperature gradient. Since the temperature of the gas flow around the shock wave surface is almost equal to the temperature of the gas reservoir, the thermal insulation of the gas flow can be enhanced. On the other hand, since the temperature at the end of the run-up preheating and accelerating system is almost equal to the temperature of the main arc column, it is increased up to about 50,000° C. or higher Therefore, the temperature difference between the inlet and outlet of the run-up preheating and accelerating system can be extremely large, the gas flow is accelerated up to the thermal velocity at the inlet of the main arc column. Moreover, since the amount of the gas flow can be maintained through the total process, the position of the shock wave is determined in the enlarged nozzle.

As mentioned above, by supplying the gas flux to the arcjet discharger via the Laval nozzle, the plasma flux with the velocity near the thermal's can be supplied to the main arc column, and thus, the total system can be operated stably.

### BRIEF DESCRIPTION OF THE DRAWINGS

For better understanding of the present invention, reference is made to the attached drawings, wherein

FIG. 1 is a structural view schematically showing an artificial solar wind generator according to the present invention.

### DESCRIPTION OF THE PREFERRED EMBODIMENTS

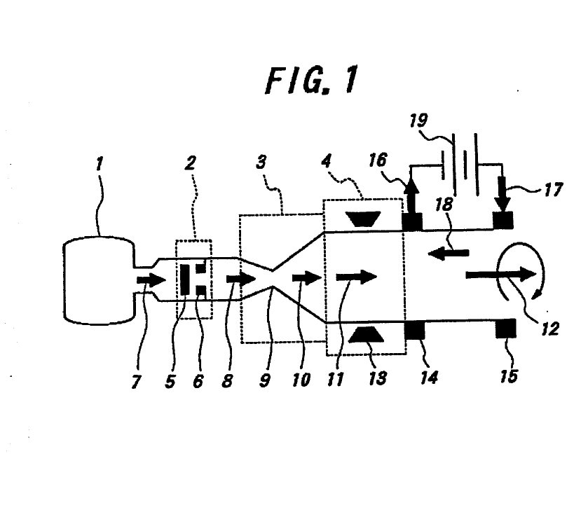

In FIG. 1, numeral “1” designates a gas reservoir, and numeral “2” designates a gas flow controlling valve, and numeral “3” designates a Laval node, and numeral “4” designates a plasma-generating preaccelerating system using high frequency discharge or direct current arc discharging system. Numeral “5” designates the moving portion of a flow-controlling valve, and numeral “6” designates a valve sheet. The plasma-generating preaccelerating system 4 is driven by an electric power supply 13.

Numeral “7” designates a gas flow from the gas reservoir 1, and numeral “8” designates a gas flow to be injected into the Laval nozzle 3 from the gas flow controlling valve. Numeral “10” designates the subsonic state of the gas flow after the relaxation of the shock wave, and numeral “11” designates the accelerating condition of the gas flow at the plasma generating preaccelerating system 4. Numeral “12” designates the state where the plasma flow is accelerated at the main arc column maintained by an arc current 18. The arc current 18 is maintained by currents 16 and 17 returning to an electric power supply 19 through electrodes 14 and 15. The electrodes 14 and 15 constructs an arcjet discharge. The gas reservoir 1 and the gas flow controlling valve 2 constructs a gas flow controlling apparatus.

The minimum sectional area 9 of the Lavel nozzle 3 and the sectional am of the gas controlling valve 2 within the moving portion 5 and the valve sheet 6 are set so that the gas flow 7 is accelerated up to super thermal velocity. in this way, the gas flow 10 which is accelerated to supersonic velocity is converted into plasma flow, to generate a primary plasma flow having a velocity of around the thermal velocity. Then, the primary plasma flow is introduced into the arcjet discharger made of the electrodes 14 and 15, and accelerated to supersonic velocity by the viscosity force, similar to a solar wind.

Although the present invention was described in detail with reference to the above examples, this invention is not limited to the above disclosure and every kind of variation and modification may be made without departing from the scope of the present invention. For example, instead of the Laval nozzle, a gas supplying tube having a throat portion which is equivalent to the Laval nozzle may be employed.

As mentioned above, according to the present invention, a solar wind can be generated artificially.

What is claimed is:

1. An artificial solar wind generator comprising an arcjet discharger, whereby a primary plasma flow is injected into said arcjet discharger from the upstream end thereof along the arc discharging axis thereof, and is accelerated up to supersonic velocity, similar to a solar wind.

2. An artificial solar wind generator as defined in claim 1, further comprising a plasma generating preaccelerating system to generate said primary plasma flow in run-up to said arcjet discharger.

3. An artificial solar wind generator as defined in claim 2, further comprising a Laval nozzle in the run-up to said plasma generating preaccelerating system.

4. An artificial solar wind generator as defined in claim 3, wherein said a Laval nozzle accelerates a gas flow up to super sonic velocity which is supplied into said plasma generating preaccelerating system and is converted into said primary plasma flow.

5. An artificial solar wind generator as defined in claim 4, further comprising a gas flow controlling apparatus to supply said gas flow to the minimum sectional area portion of said Laval nozzle at sonic velocity

6. An artificial solar wind generator as defined in claim 2, further comprising a gas supplying tube having a throat portion which is equivalent to a Laval nozzle in the run-up to said plasma generating preaccelerating system.

7. An artificial solar wind generator as defined in claim 6, wherein said gas supplying tube accelerates a gas flow up to super sonic velocity at the minimum sectional area portion thereof which is supplied into said plasma generating preaccelerating system and is converted into said primary plasma flow.

8. An artificial solar wind generator as defined in claim 7, further comprising a gas flow controlling apparatus to supply said gas flow to said minimum sectional area portion of said gas supplying tube at sonic velocity.
